(19) United States
(12) Patent Application Publication
(10) Pub. No.: US 2013/0010064 A1
(43) Pub. Date: Jan. 10, 2013

(54) VIDEO PROCESSING DEVICE

(75) Inventor: Tadayoshi Okuda, Osaka (JP)

(73) Assignee: PANASONIC CORPORATION, Osaka (JP)

(21) Appl. No.: 13/636,429

(22) PCT Filed: Mar. 24, 2011
(86) PCT No.: PCT/JP2011/001728

§ 371 Date: Sep. 21, 2012

(30) Foreign Application Priority Data
Mar. 24, 2010 (JP) 2010-067592

(51) Int. Cl. H04N 13/02; H04N 13/00

(52) U.S. Cl. 348/43; 348/E13.063; 348/E13.026

(57) ABSTRACT

A video processing device, which can output stereoscopic video information that enables stereoscopic viewing to a video display device, includes an obtaining unit that obtains the stereoscopic video information, a superimposing unit that superimposes additional video information on the stereoscopic video information, and a transmitting unit that transmits parallax information of the additional video information to the video display device, with the parallax information being associated with the stereoscopic video information on which the additional video information is superimposed.

### TECHNICAL FIELD

The invention relates to a video processing device which outputs stereoscopic video information that enables stereoscopic viewing.

### BACKGROUND ART

The Patent Document 1 discloses a display controller capable of displaying stereoscopic images (video) with subtitles superimposed thereon. The display controller adjusts a display position of the subtitle in a depth direction (direction orthogonal to a display screen) so that the subtitle can be displayed at an appropriate position relative to a stereoscopic image.

### PRIOR ART DOCUMENT

### Patent Document

Patent Document 1: JP 2004-274125 A

### SUMMARY OF INVENTION

### Problem to be Solved by the Invention

A conventional video display device such as a television, has a function to superimpose an image (hereinafter, called “device image”) created by the video display device on an original stereoscopic image and display the resulting image. The device image is, for example, an image (OSD: On Screen Display) indicating information of channels and sound volume, information used to adjust luminance, degree of contrast, and color temperature, and information used to adjust an image quality of the display apparatus. Similarly, an image reproduction apparatus which outputs image data to a video display device, for example, an optical disc player, has a function to superimpose a device image created by the image reproduction apparatus on an original stereoscopic image and output the resulting image.

When displaying the device image during the display of the stereoscopic image, the video display device needs to suitably adjust a display position of the device image in a depth direction (direction orthogonal to a display screen). Such an adjustment is necessary because the device image, if displayed at a position farther than the original stereoscopic image in the depth direction (direction away from a viewer), results in an image that visually causes a sense of discomfort for the viewer. To avoid such an unpleasant image, the device image of the display apparatus needs to adjust parallax similarly to subtitles.

On the other hand, a video processing device reads out video data from a video source (for example, optical disc) and decodes and outputs the read video data to a video display device. In this case, the video processing device may superimpose the subtitle and the device image added by the video processing device on the original stereoscopic image and output the resulting stereoscopic video information to the video display device.

In this case, the video display device can not recognize these processes by the video processing device. For example, it is not possible for the video display device to recognize an amount of parallax of the subtitle superimposed by the video processing device and the device image. Therefore, it is difficult for the video display device, when superimposing a device image by the video display device on the stereoscopic image received from the video processing device, to adjust the amount of parallax of the device image by the video display device to be superimposed to an appropriate value, thereby failing to display a good stereoscopic image visually pleasant to a user.

To solve the problem, the invention provides a stereoscopic video processing device that can provide a stereoscopic video display device with video information to enable a stereoscopic image visually pleasant for a user to be displayed on the stereoscopic video display device.

### Means for Solving the Problems

A video processing device according to the invention is an apparatus capable of outputting stereoscopic video information that enables stereoscopic viewing to a video display device. The video processing device includes an obtaining unit that obtains the stereoscopic video information, a superimposing unit that superimposes additional video information on the stereoscopic video information, and a transmitting unit that transmits parallax information of the additional video information to the video display device, with the parallax information being associated with the stereoscopic video information on which the additional video information is superimposed.

### Effect of the Invention

In the video processing device according to the invention, the parallax information of the processed (decoded) stereoscopic video information can be transmitted to the video display device in a simpler manner. By using the parallax information, the video display device can locate the device image of the video display device (OSD) at a more appropriate position. As a result, the video display device can display the self device image (OSD) that is visually pleasant to a viewer.

### BRIEF DESCRIPTION OF DRAWINGS

FIG. 1 is a view for describing the object of the invention;

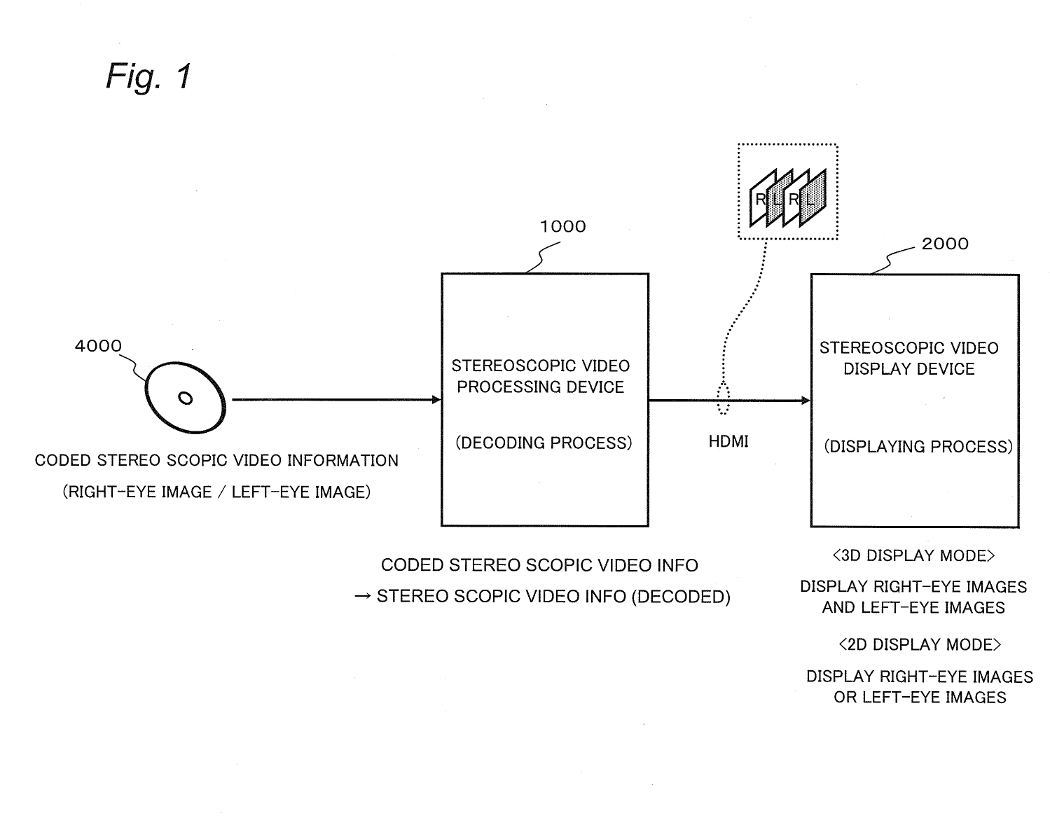

FIG. 2 is a view for schematically describing compression coding of stereoscopic video information;

FIG. 3 is a view of a stereoscopic video stream;

FIG. 4 is a block diagram illustrating structural characteristics of a stereoscopic imaging system;

FIG. 5 is a block diagram illustrating structural characteristics of a stereoscopic video processing device;

FIG. 6 is a view for describing an example in which a subtitle image and a processing device image are superimposed on stereoscopic image data;

FIG. 7 is a view for describing an example in which a subtitle image and a processing device image are superimposed on stereoscopic image data;

FIG. 8 is a view for describing output data transmitted from the stereoscopic video processing device to the stereoscopic video display device;

FIG. 9 is a block diagram illustrating structural characteristics of a stereoscopic video display device;

FIG. 10A is a view for describing a method of displaying stereoscopic video information;

FIG. 10B is a view for describing a method of displaying stereoscopic video information;

FIG. 11 is an illustration of an operation for displaying three-dimensional images;

FIG. 12 is an illustration of an operation for displaying three-dimensional images;

FIG. 13 is an illustration of an operation for displaying two-dimensional images;

FIG. 14 is an illustration of an operation for displaying two-dimensional images;

FIG. 15 is a view for describing a region of a subtitle included in a display image and a region of a processing device image; and

FIG. 16 is an illustration of a format used for transmitting parallax information with information of a region in which an object is displayed.

### MODE FOR CARRYING OUT THE INVENTION

Hereinafter, embodiments of the invention are described referring to the accompanied drawings.

### 1. Overview

A stereoscopic video processing device according to an embodiment described hereinafter obtains coded stereoscopic video information which is generated by coding stereoscopic video information and converts the coded stereoscopic video information into a format that can be displayed on a stereoscopic video display device. Thus, the stereoscopic video processing device obtains and decodes the coded stereoscopic video information. Then, the stereoscopic video processing device associates identification information indicating one of a left-eye image and a right-eye image having a higher average bit rate for coding than the other with the decoded stereoscopic video information and transmits the resulting information to the stereoscopic video display device. When displaying two-dimensional images based on the stereoscopic video information received from the stereoscopic video processing device, the stereoscopic video display device generates and displays the two-dimensional images (left-eye image or right-eye image) based on the identification information. These processes are described in detail below. The description is hereinafter made in the order of video content to be reproduced, video content compression technique, video content multiplexing technique, structural characteristics and operation of stereoscopic video display system, and other embodiments.

### 2. Video Content

According to the present embodiment, a video content includes stereoscopic video information, audio information, and data information.

The stereoscopic video information includes left-eye image data and right-eye image data. An object included in each of the left-eye image data and right-eye image data has parallax. The parallax allows a viewer to visually recognize a three-dimensional image, when the images are displayed so that the left-eye image and the right-eye image are respectively viewed by the viewer with his left eye and right eye.

The audio information is information of sound or voice that can be outputted in synchronization with the stereoscopic video information (video stream).

The data information includes subtitle data and sub-image data. The sub-image data is, for example, bonus footage such as bonus view and/or graphics menu. To present a three-dimensional image, the subtitle data and the sub-image data has parallax information added thereto. The parallax information added to the subtitle data is called “subtitle parallax information”, and the parallax information added to the sub-image data is called “sub-image parallax information”. To display the subtitle as a stereoscopic image, the subtitle parallax information is used to superimpose the subtitle data on the left-eye image data and the right-eye image data. Then, the subtitle is viewed by a viewer as a stereoscopic image.

The subtitle parallax information represents an amount of displacement of a subtitle display position in a horizontal direction when the subtitle is displayed on a display screen. The same goes for the sub-image parallax information. The parallax information representing the amount of displacement may be expressed in number of pixels or in the unit of mm. The amount of displacement indicated by the parallax information corresponds to a display position of an image in a depth direction of the screen when the image is stereoscopically displayed.

### 3. Compression-Coded Video Content (Stereoscopic Video Information, Audio Information, Data Information)

The stereoscopic video information is coded and compressed. Regarding the compression of the stereoscopic image in the present embodiment, one (for example, right-eye image) of the left-eye image and the right-eye image composing a stereoscopic image is compressed at a higher compression rate (at a lower average bit rate) than that of the other image (for example, left-eye image). One of the images composing a stereoscopic image that has a lower compression rate is hereinafter called “first eye image”, while the other image having a higher compression rate is called “second eye image”. Below is described a specific example.

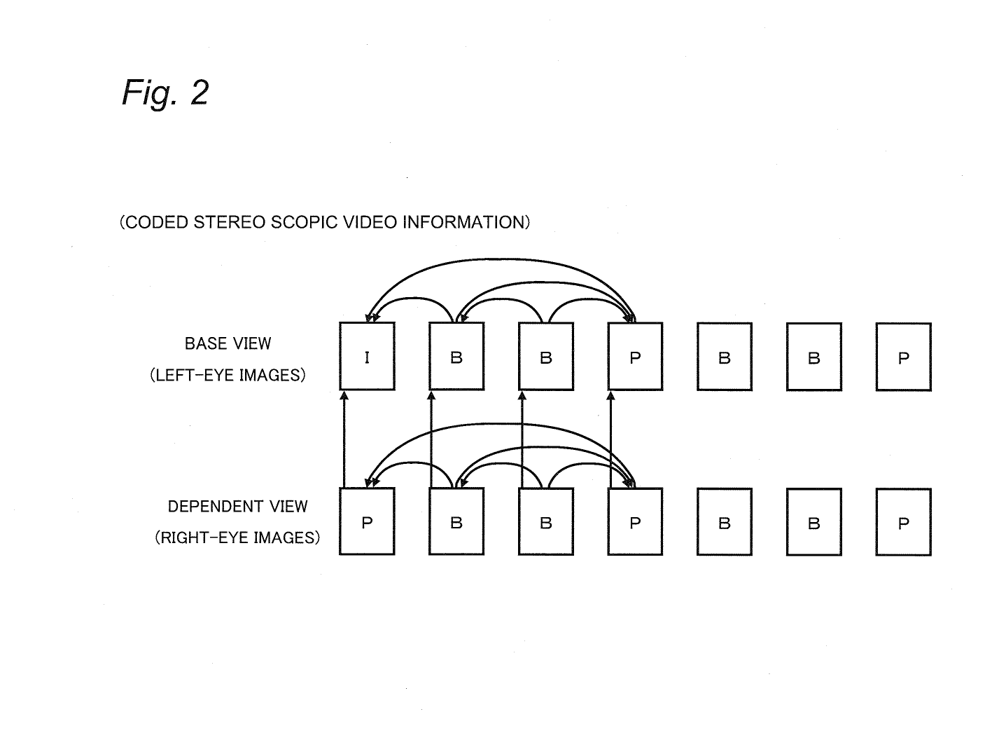

For example, the stereoscopic video information can be compressed by multi-view video cording (MVC). MVC is a coding technique for integrally coding a plurality of images. According to the present embodiment, first eye image (left-eye image in the illustrated example) data is coded by inter-frame predictive coding based on only the first eye image data alone as illustrated in FIG. 2. On the other hand, the second eye image (right-eye image in the illustrated example) data is coded by inter-frame predictive coding by using the first and second eye image data. The first eye image (left-eye image) data includes P frame for forward prediction, B frame for bidirectional prediction, and I frame for intra-frame coding. The second eye image (right-eye image) data, however, includes P frame for forward prediction and B frame for bidirectional prediction, without I frame for intra-frame coding. According to the MVC, an image coded based on its own image data alone, such as the first eye image, is called “base view”, and an image coded based on its own image data and other image data, such as the second eye image, is called “dependent view”.

When coded by the MVC technique, the second eye image not having I frame and enabling inter-frame prediction even from the first eye image can lower the average bit rate as compared to the first eye image, greatly improving an efficiency in compression.

In place of the MVC technique, MPEG4-AVC/H.264 may be used for compression coding. Although the description given so far does not refer to any coding technique for the audio information or the data information, various types of conventional technique can be applied to these pieces of information.

### 4. Video Content Multiplexing Technique

Below is described a multiplexing technique for transferring the compression-coded stereoscopic video information, audio information, and data information such that these pieces of information are associated with one another.

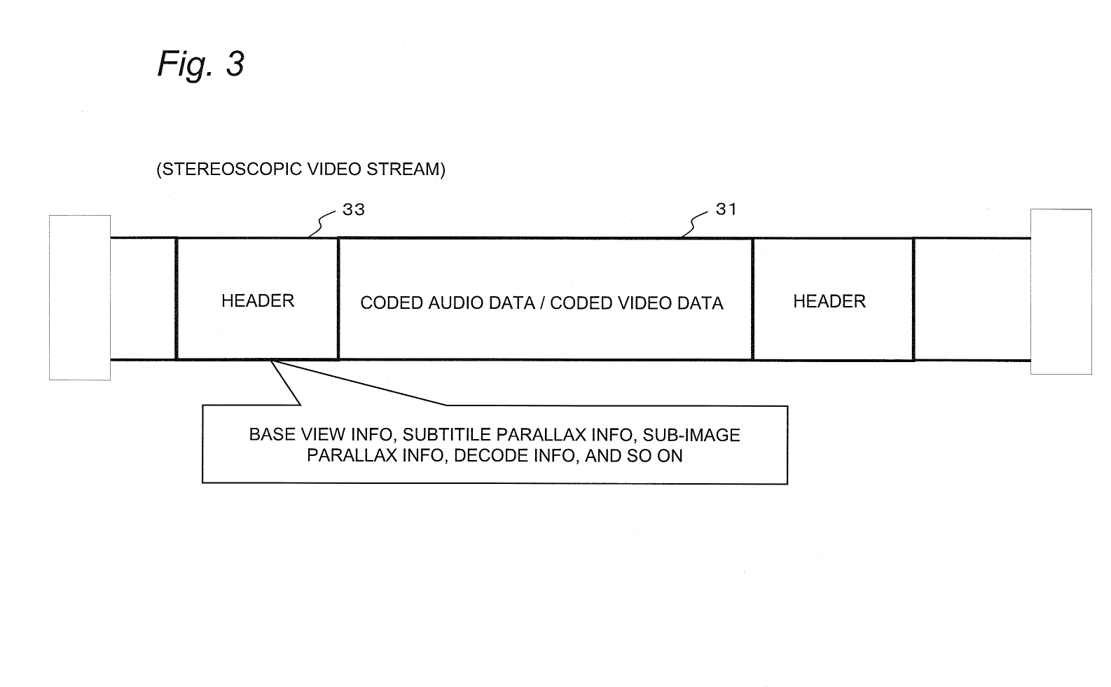

The stereoscopic video information, audio information, and data information are multiplexed together. A number of multiplexing techniques are available. For example, conversion to PS (program stream) and TS (transport stream) is available for storage (such as optical disc), and conversion to TS is available for broadcast/communication (such as broadcast wave). A stream generated by multiplexing the stereoscopic video information, audio information, and data information is called a stereoscopic video stream. FIG. 3 is an illustration of a stereoscopic video stream. As illustrated in the drawing, the stereoscopic video stream includes coded data 31, and header information 33.

A part of the header information 33 includes information (hereinafter, called “base view information”) indicating whether the base view of the stereoscopic video information is the left-eye image or the right-eye image. According to the present embodiment, since the left-eye image is used as the base view image, base view information indicating that the base view image is the left-eye image is added to the header information 33. The base view information is used to decode the stereoscopic video information.

According to the present embodiment, the subtitle parallax information and the sub-image parallax information are further included in a part of the header information 33.

### 5. Configuration of Stereoscopic Video Display System

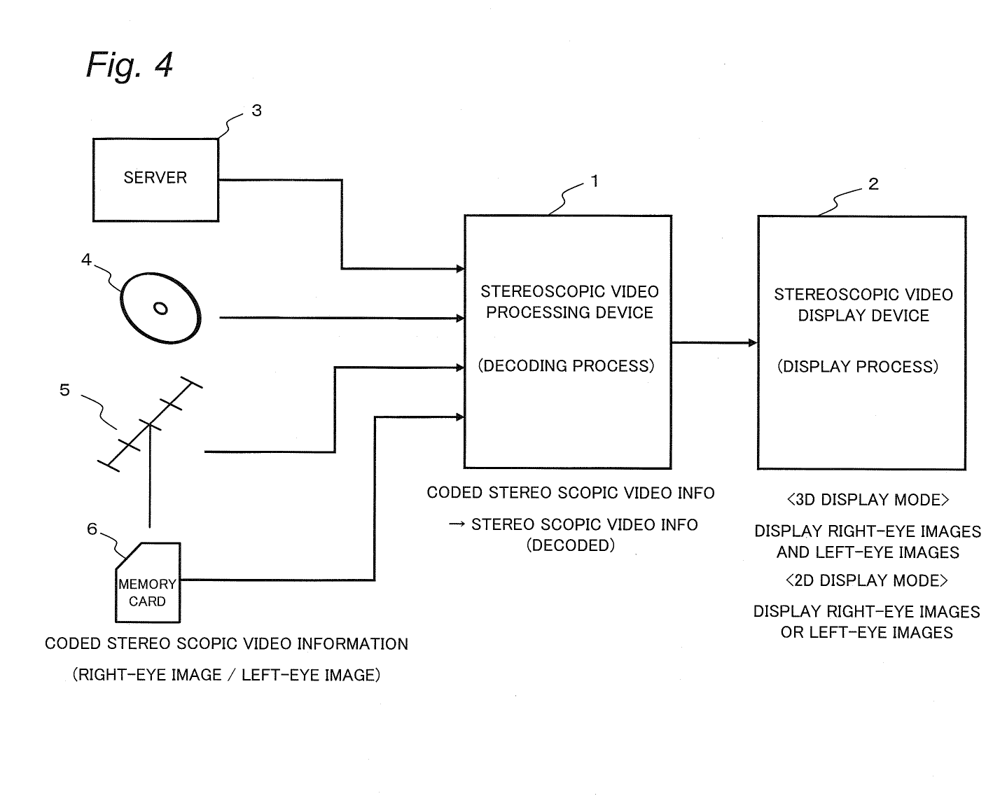

FIG. 4 illustrates a configuration of a stereoscopic video display system according to the present embodiment. The stereoscopic video display system includes a stereoscopic video processing device 1 and a stereoscopic video display device 2. First, an overview of the stereoscopic video display system is described, and the stereoscopic video processing device 1 and the stereoscopic video display device 2 will be described later.

As illustrated in FIG. 4, the stereoscopic video processing device 1 is connected to the stereoscopic video display device 2 for displaying stereoscopic image, a server 3 which stores the stereoscopic video streams, and an antenna 5. An optical disc 4 and a memory card 6 are currently inserted in the stereoscopic video processing device 1. The stereoscopic video processing device 1 obtains the stereoscopic video stream from the server 3, optical disc 4, antenna 5, or memory card 6.

The server 3 is a network server which stores the stereoscopic video streams. The server 3 is connected to a network and connectable to the stereoscopic video processing device 1 located in a house through the network. The server 3 can transmit the stereoscopic video stream to the stereoscopic video processing device 1 (network communication interface 13) in response to an access request transmitted from the stereoscopic video processing device 1.

The optical disc 4 is a recording medium which stores the stereoscopic video streams. The optical disc 4 can be inserted in a disc drive 11 of the stereoscopic video processing device 1. The stereoscopic video processing device 1 (disc drive 11) can read out the stereoscopic video streams recorded on the optical disc 4.

The antenna 5 receives broadcast wave containing the stereoscopic video stream which is broadcasted from a broadcast apparatus of a broadcast station. The antenna 5 transmits the received broadcast wave including the stereoscopic video stream to the stereoscopic video processing device 1 (tuner 12).

The memory card 6 is a semiconductor memory card for storing the stereoscopic video streams or a recording medium including a semiconductor memory for storing the stereoscopic video streams. The memory card 6 can be inserted in the stereoscopic video processing device 1 (data transmission interface 15). The stereoscopic video processing device 1 (data transmission interface 15) can read out the stereoscopic video streams recorded on the memory card 6.

### 5-1. Configuration of Stereoscopic Video Processing Device

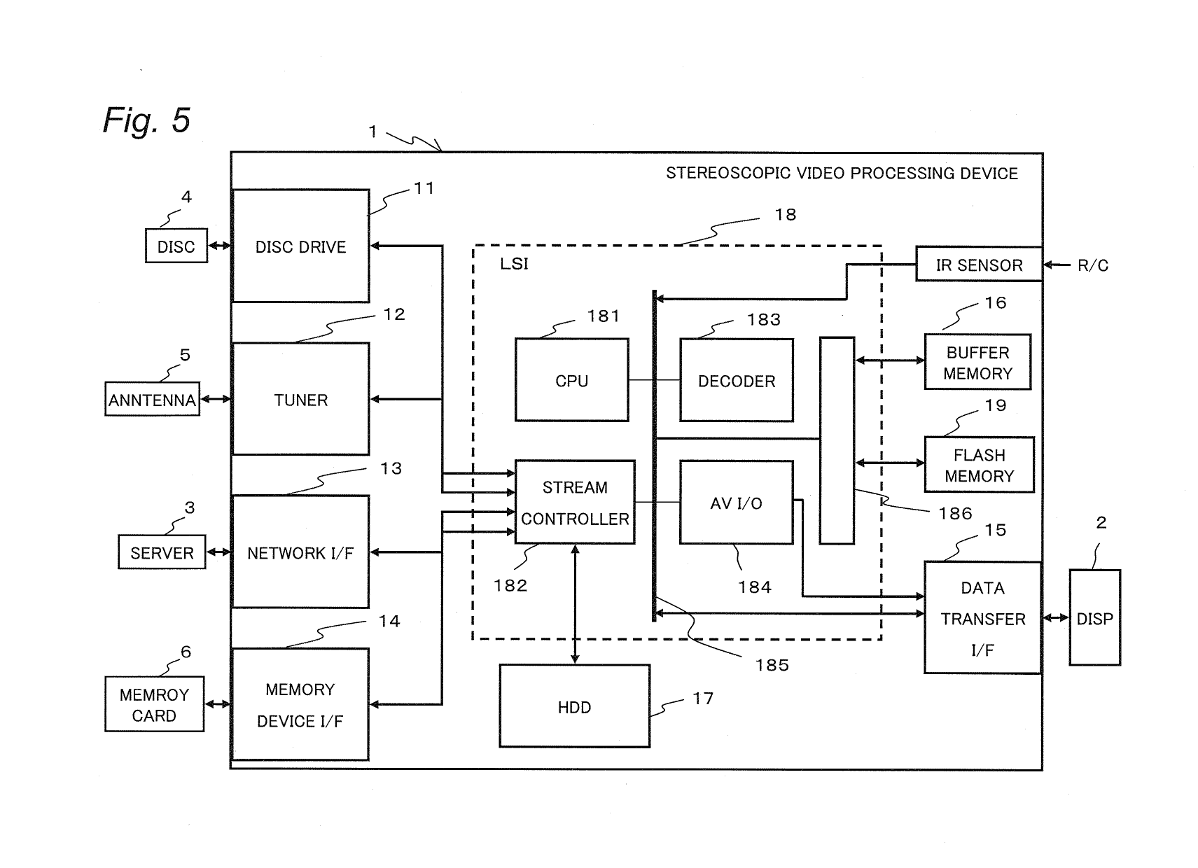

Hereinafter, configuration of the stereoscopic video processing device 1 is described referring to FIG. 5. The stereoscopic video processing device 1 includes a disc drive 11, a tuner 12, a network communication interface 13, a memory device interface 14, a data transmission interface 15, a buffer memory (frame memory) 16, an HD drive 17, a flash memory 19, and an LSI 18.

The disc drive 11 including an optical pickup reads out the stereoscopic video stream from the optical disc 4. The disc drive 11 is connected to the LSI 18 to transmit the stereoscopic video stream read from the optical disc 4 to the LSI 18. The disc drive 11 reads out the stereoscopic video stream from the optical disc 4 and transmits the read stream to the LSI 18 under the control from the LSI 18.

The tuner 12 obtains the broadcast wave including the stereoscopic video stream received by the antenna 5. The tuner 12 extracts the stereoscopic video stream having a frequency requested by the LSI 18 from the obtained broadcast wave. The tuner 12 is connected to the LSI 18 to transmit the extracted stereoscopic video stream to the LSI 18.

The network communication interface 13 is in charge of controlling connection to the network. According to the present embodiment, the stereoscopic video processing device 1 is connectable to the server 3 through the network communication interface 13 and the network. The network communication interface 13 obtains the stereoscopic video stream transmitted from the server 3.

The memory device interface 14 is an interface into which the memory card 6 is inserted, and can receive the stereoscopic video stream from the inserted memory card 6. The memory device interface 14 transmits the stereoscopic video stream read from the memory card 6 to the LSI 18.

The HD drive 17 incorporates a recording medium, such as a hard disc, and transmits data read from the recording medium to the LSI 18. Further, the HD drive 17 records data received from the LSI 18 on the recording medium.

The data transmission interface 15 is an interface used to transmit data outputted from the LSI 18 to the stereoscopic video display device 2 located externally. The data transmission interface 15 is configured to transmit and receive a data signal and a control signal to and from the stereoscopic video display device 2. The LSI 18 can control the stereoscopic video display device 2 through the data transmission interface 15. The data transmission interface 15 performs communication in compliance with HDMI (High-Definition Multimedia Interface). The data transmission interface 15 is connected to the stereoscopic video display device 2 with an HDMI cable. The HDMI cable includes a data line and a control line. As far as the data signal can be transmitted to the stereoscopic video display device 2, the data transmission interface 15 is not necessarily limited structurally or technically.

The buffer memory 16 functions as a work memory for processes to be executed by the LSI 18. Examples of the buffer memory 16 are DRAM and SRAM.

The flash memory 19 stores device image data of the stereoscopic video processing device 1 in advance. The device image includes, for example, information of channels and sound volume, information used to adjust luminance, degree of contrast, and color temperature, and information used to adjust an image quality of a video reproduction apparatus. The LSI 18 can superimpose the device image read from the flash memory 19 on the image data and display the resulting image data on the stereoscopic video display device 2. Thus, the LSI 18 can present information of the stereoscopic video processing device 1 to a viewer. The LSI 18 controls to display a setting screen. The LSI 18 can receive a requested setting inputted by a viewer on the setting screen.

The LSI 18 is a system controller in charge of controlling the respective structural elements of the stereoscopic video processing device 1, and can be realized by a microcomputer and a hard-wired circuit. The LSI 18 is mounted with a CPU 181, a stream controller 182, a decoder 183, an AV input/output circuit 184, a system bus 185, and a memory controller 186.

The CPU 181 controls the whole LSI 18. The respective structural elements of the LSI 18 are respectively controlled by the LSI 18 to execute various controls. The CPU 181 also controls communications with external apparatuses. When, for example, the stereoscopic video stream is obtained from the server 3, the CPU 181 transmits control signals to the disc drive 11, tuner 12, network communication interface 13, and memory device interface 14.

Accordingly, the disc drive 11, tuner 12, network communication interface 13, and memory device interface 14 can obtain the stereoscopic video stream from, for example, the recording medium or broadcast station.

The stream controller 182 controls data transmission and reception to and from the server 3, optical disc 4, antenna 5, memory card 6, and active shutter glasses (described later). For example, the CPU 181 transmits the stereoscopic video stream obtained from the server 3 to the memory controller 186.

The memory controller 186 writes the data transmitted from the devices of the LSI 18 in the buffer memory 16. For example, the memory controller 186 writes the stereoscopic video stream obtained from the stream controller 182 in the buffer memory 16. The memory controller 186 reads the data recorded on the buffer memory 16 from the buffer memory 16. Then, the buffer memory 16 transmits the read data to the devices of the LSI 18.

The decoder 183, when the data is obtained from the memory controller 186, decodes the obtained data. The data input to the decoder 183 is controlled by the CPU 181. More specifically, the CPU 181 causes the memory controller 186 to read out the stereoscopic video stream recorded on the buffer memory 16. Then, the CPU 181 causes the memory controller 186 to transmit the read stereoscopic video stream to the decoder 183. Thus, the stereoscopic video stream is inputted from the memory controller 186 to the decoder 183.

The decoder 183 splits the inputted stereoscopic video stream into the coded data 31 (compression-coded stereoscopic video information, compression-coded audio information, and compression-coded data information) and the header information 33. The decoder 183 records the header information 33 on the buffer memory 16.

The decoder 183 decodes the compressed data 31 based on decoding information contained in the header information 33. The decoder 183 transmits the decoded information (stereoscopic video information, audio information, and data information) to the memory controller 186. The memory controller 186 records the information received from the decoder 183 to the buffer memory 16.

The AV input/output circuit 184 reads out the information of the decoded data 31 and the header information 33 from the buffer memory 16 and generates output data to be displayed on the stereoscopic video display device 2 based on the read information. The AV input/output circuit 184 transmits the generated output data to the stereoscopic video display device 2 through the data transmission interface 15. At the same time, the stream controller 182 and the decoder 183 analyze the header information 33 to obtain the base view information. The AV input/output circuit 184 contains the base view information in the output data as identification information indicating one of the left-eye image and the right-eye image having a higher average bit rate higher than the other. Though the present embodiment uses the base view information as the identification information, the identification information is not necessarily limited to the base view information but may be any information indicating one of the left-eye image and the right-eye image having a higher average bit rate for coding than the other. For example, the AV input/output circuit 184 may generate the identification information by analyzing the stereoscopic video stream to determine which of the left-eye image and the right-eye image has an average bit rate for coding higher than the other. The identification information is contained in the output data per frame.

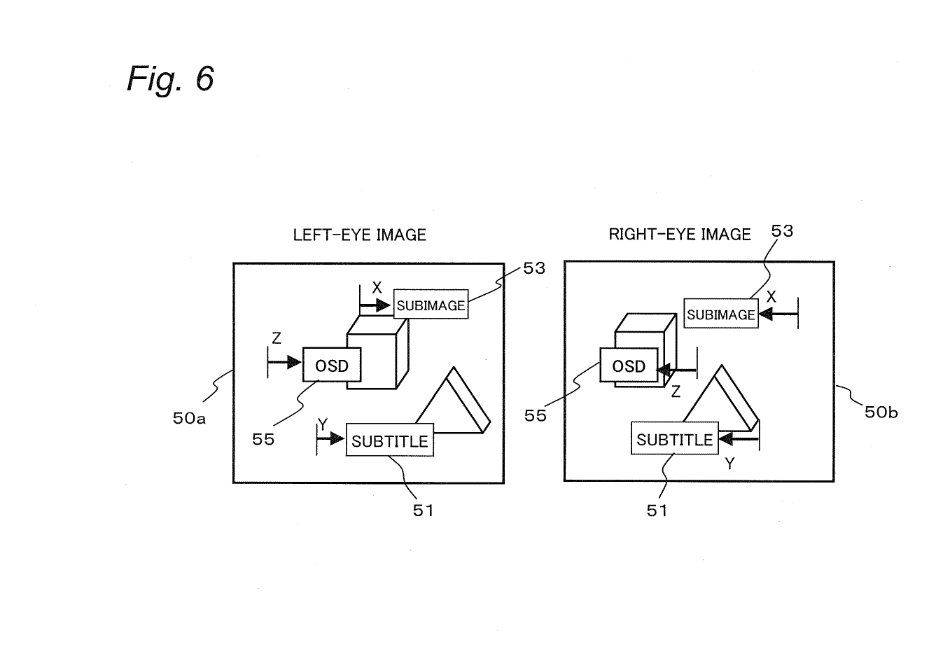

More specifically, the AV input/output circuit 184 generates such output data that is illustrated in FIG. 6. The AV input/output circuit 184 performs two processing steps for generating the output data. A first one of the steps is a display image generating step, and a second one is an output data generating step. These processing steps are hereinafter described.

### 5-1-1. Display Image Generating Process

The display image generating process is a process for processing the stereoscopic video information (left-eye image or right-eye image) according to an instruction from a viewer. More specifically, this process is performed when an instruction to display the subtitle or an instruction to display the sub image or the device image of the stereoscopic video processing device 1 (hereinafter, called processing device image) is received from a viewer. The viewer can input any of the instructions to the stereoscopic video processing device 1 using a remote controller. The instructions inputted through the remote controller can be received by an infrared sensor provided in the stereoscopic video processing device 1. The process is described referring to a specific example below.

When the stereoscopic video processing device 1 receives the instruction to display the subtitle image inputted by a viewer, the AV input/output circuit 184 superimposes the subtitle image on the stereoscopic image data. More specifically, the AV input/output circuit 184 obtains the header information 33 from the buffer memory 16 and superimposes the subtitle image on the left-eye image or the right-eye image based on the parallax information of the subtitle image. For example, when the parallax information of the subtitle image (amount of displacement) indicates Y pixels as illustrated in FIG. 6, the AV input/output circuit 184 displaces a subtitle image 51 to right by Y pixels and superimposes the resulting subtitle image 51 on a left-eye image 50a. Further, the AV input/output circuit 184 displaces the subtitle image 51 to left by Y pixels and superimposes the resulting subtitle image 51 on a right-eye image 50b. The same holds true for a sub image 53 added to the stereoscopic images 50a and 50b.

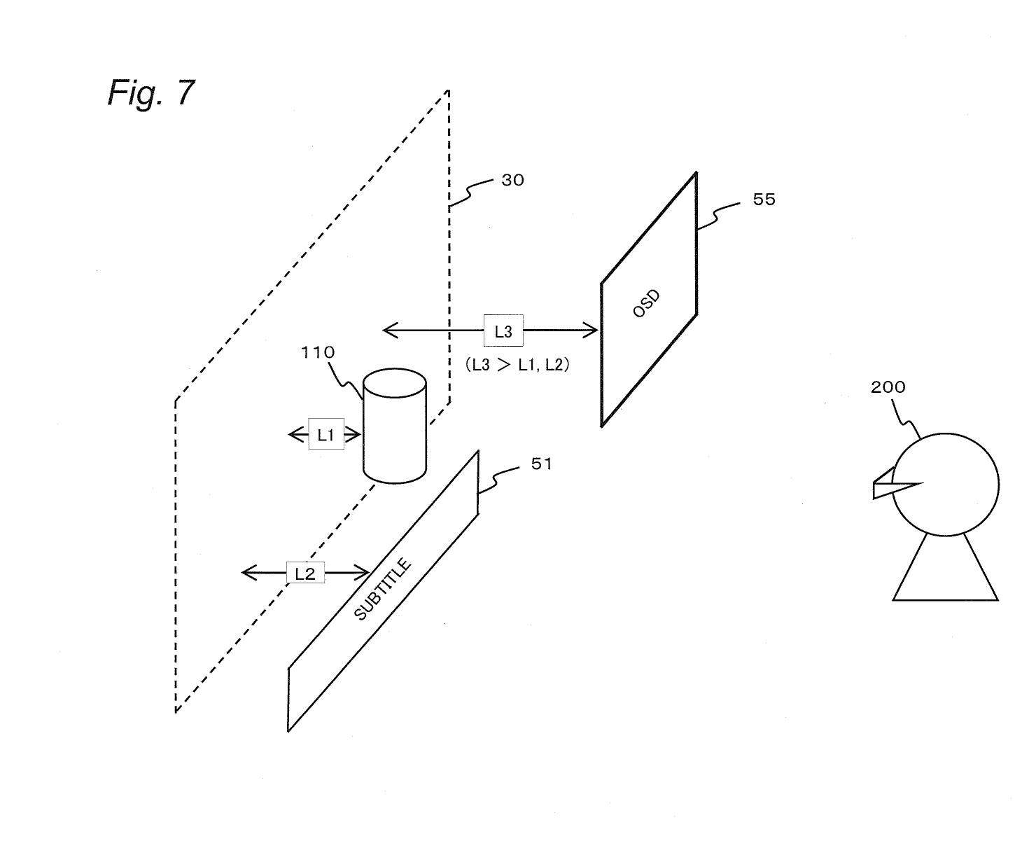

When instructed by a viewer to display the processing device image in addition to the instruction to display the subtitle, the AV input/output circuit 184 obtains the processing device image requested by the instruction (for example, function menu image provided by the stereoscopic video processing device 1) from the flash memory 19. Then, the AV input/output circuit 184 obtains the parallax information of the subtitle image from the buffer memory 16. The AV input/output circuit 184 decides the parallax information of the processing device image based on the obtained parallax information of the subtitle image. More specifically, the AV input/output circuit 184 decides the parallax information (for example, Z pixels) so that the processing device image is stereoscopically displayed forward in a depth direction of the screen (viewer side) relative to the subtitle image. That is, the parallax information is decided so that the parallax of the device image is larger than the parallax of the subtitle image. In such a stereoscopic display that is illustrated in FIG. 7 wherein an object 110 and a subtitle 51 stereoscopically displayed are displayed closer to a viewer 200 than a screen 30 of the stereoscopic video display device 2, the parallax information of a processing device image 55 is decided so that the processing device image 55 is displayed forward (viewer side) relative to the subtitle 51. The object 110 stereoscopically displayed is an object displayed closer to the viewer 200 than any other objects stereoscopically displayed, and the subtitle 51 is displayed even closer to the viewer 200 than the object 110. Since the processing device image 55 is thus displayed forward (viewer side) relative to the object 110 and the subtitle 51 stereoscopically displayed, the viewer can view the processing device image 55 without feeling a sense of visual discomfort.

The AV input/output circuit 184 performs superimposition of the processing device image based on the parallax information thus decided.

For example, when the parallax information of the subtitle image (amount of displacement) indicates Z pixels as illustrated in FIG. 6, the AV input/output circuit 184 displaces the processing device image 55 to right by Z pixels and superimposes the resulting processing device image 55 on the left-eye image 50a. Further, the AV input/output circuit 184 displaces the processing device image 55 to left by Z pixels and superimposes the resulting processing device image 55 on the right-eye image 50b. The AV input/output circuit 184 generates image data containing the left-eye image 50a and the right-eye image 50b on which the processing device image 55 is superimposed.

### 5-1-2 Output Data Generating Process

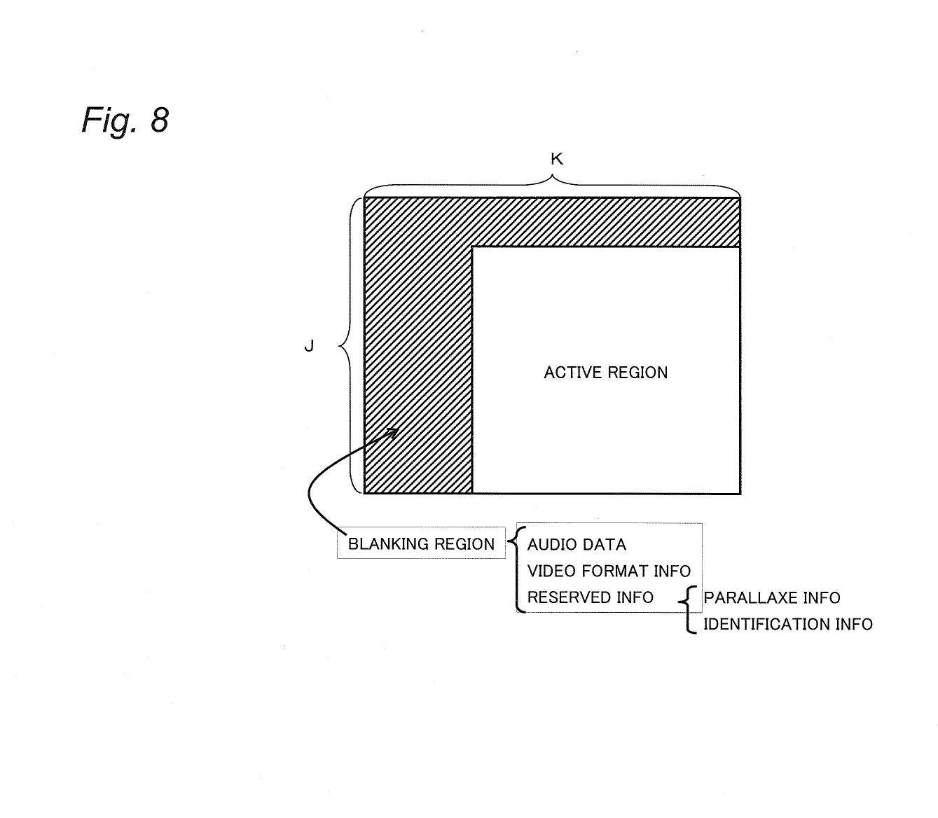

The AV input/output circuit 184 generates output data that is illustrated in FIG. 8. As illustrated in FIG. 8, the output data is data of JXK pixels including an image ineffective section (blanking region) and an image effective section (active region).

The active region includes the display image generated in the display image generating process. The data transmission interface, such as HDMI, packetizes, for example, audio data, video format information, and reserved information in the blanking region and transmits the pieces of packetized information. The audio data includes audio information for images included in the active region. The video format information includes information about a screen aspect ratio, resolution, and so on. The reserved information includes identification information indicating one of the left-eye image and the right-eye image having a higher average bit rate for coding than the other. The present embodiment uses the base view information as the identification information. The reserved information further includes maximum parallax information of the display image generated by the display image generating process. For example, when superimposition of the processing device image is performed in the display image generating process, parallax information Z is obtained. A calculation method of the maximum parallax information is described later.

According to the present embodiment, the identification information is information indicating one of the left-eye image and the right-eye image having a higher average bit rate for coding than the other. However, the identification information is not necessarily limited thereto but may be information indicating which of the images includes I frame during coding. Therefore in the case of an MVC-coded image, the decoder detects which of the left-eye image and the right-eye image includes I frame, and the identification information is generated based on the detected information.

According to the present embodiment, the reserved information includes, per frame, the identification information indicating one of the left-eye image and the right-eye image having a higher average bit rate for coding than the other. However, in the reserved information, the identification information may be included per n frames (n>1), or the identification information may be included by each timing of switching the base view from the left-eye image to the right-eye image (or vice versa).

The AV input/output circuit 184 transmits the data generated in the two processes to the stereoscopic video display device 2 through the data transmission interface 15.

### 5-1-3. Calculation Method of Maximum Parallax Information

The calculation method of the maximum parallax information mentioned earlier is described referring to two examples.

### Example 1

### Case in which the Subtitle Data and the Device Image of the Stereoscopic Video Processing Device 1 are Superimposed on the Stereoscopic Video Information

Information to be extracted is recited below.

TABLE 1

| | parallax information |
|---|---|
| stereoscopic video information | unknown |
| subtitle data | Y |
| sub-image data | X (X < Y) |
| device image of stereoscopic video | Z (Z > Y) |
| processing device | |

It is assumed that the parallax information of the device image of the stereoscopic video processing device 1 is adjusted so that the device image is displayed closer to a viewer than the subtitle data.

In this case, the parallax information Z is larger than the parallax information Y of the subtitle data, and thus the maximum parallax information is Z. Even if the parallax information X is larger than Z, the maximum parallax information is Z because the sub image is not superimposed on the stereoscopic video information.

### Example 2

### Case in which No Other Images are Superimposed on the Stereoscopic Video Information

Information to be extracted is recited below.

TABLE 2

| | parallax information |
|---|---|
| stereoscopic video information | unknown |
| subtitle data | Y |
| sub-image data | X (X < Y) |

Then, the maximum parallax information is X. In the example 2, the stereoscopic video information has no parallax information. It is difficult to obtain the parallax information by analyzing the stereoscopic video information, and thus the parallax information of the subtitle data or the sub-image data is used to obtain the maximum parallax information. In the present embodiment, the parallax information of the sub-image data (minimum parallax in all of non-superimposed data) is used. By displaying the device image of the stereoscopic video display device 2 based on the maximum parallax information thus obtained, a sense of visual discomfort that a viewer may feel can be lessened. The parallax information Y of the subtitle data may be used as the maximum parallax information.

In the case where the stereoscopic video processing device is provided with a circuit which detects the parallax information of the stereoscopic video information, by comparing the parallax information of the stereoscopic video information that can be detected by the circuit with the parallax information of the subtitle data and the sub-image data, the maximum parallax information in these pieces of parallax information can be obtained.

### 5-2. Configuration of Stereoscopic Video Display Device

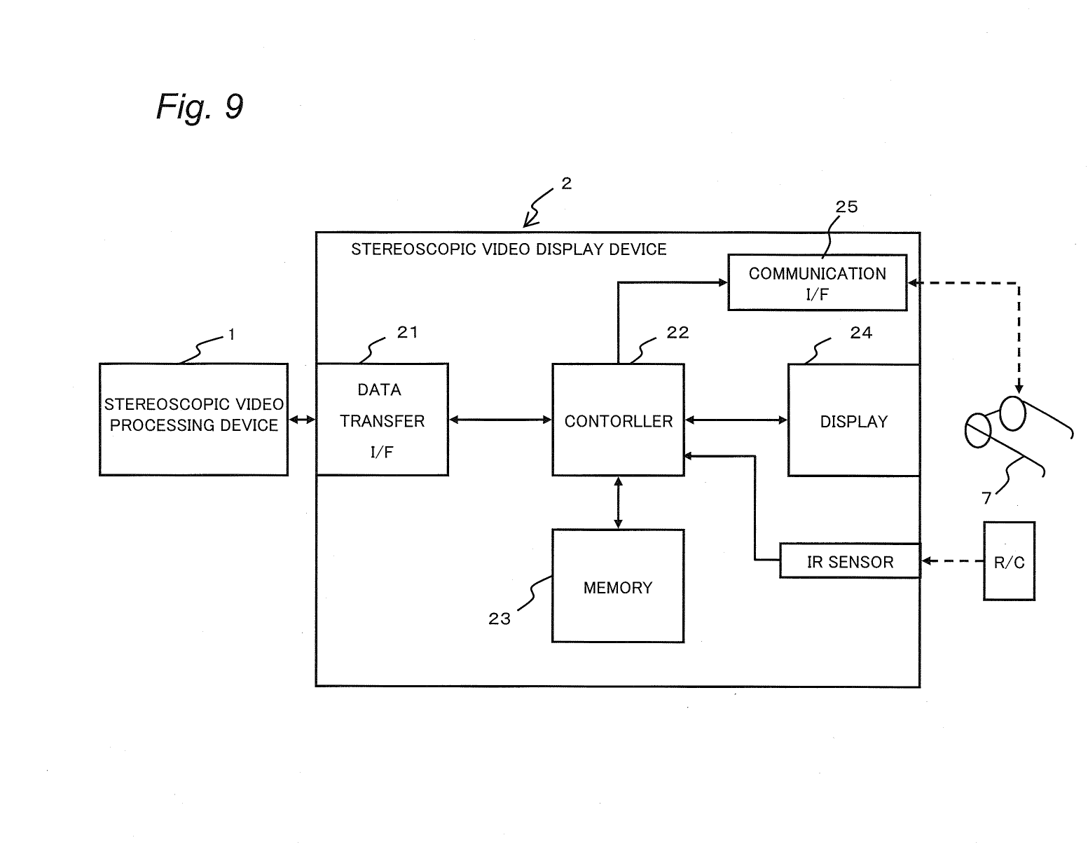

FIG. 9 illustrates a configuration of the stereoscopic video display device 2. The stereoscopic video display device 2 has a display 24 to display thereon the image data (display image) included in the output data transmitted from the stereoscopic video processing device 1. The display 24 is, for example, implemented by a liquid crystal display, a plasma display, or an organic EL display. Thus, the stereoscopic video display device 2 can display thereon the images included in the output data transmitted from the stereoscopic video processing device 1.

More specifically, the stereoscopic video display device 2 includes a controller 22, a memory 23, a display 24, a data transmission interface 21, and a communication interface 25. The memory 23 is implemented by, for example a flash memory or a DRAM. The controller 22 is implemented by a microprocessor, for example.

The data transmission interface 21 is an interface for transmitting and receiving data between the stereoscopic video processing device 1 and the stereoscopic video display device 2. The data transmission interface 21 performs communication in compliance with HDMI (High-Definition Multimedia Interface).

The communication interface 25 is an interface for performing communication with active shutter glasses 7. The communication interface 25 establishes the communication with the active shutter glasses 7 through wired or wireless communication, for example, infrared or Bluetooth communication.

The stereoscopic video display device 2 can switch a display mode between a three-dimensional video display mode and a two-dimensional video display mode in response to signals outputted from a remote controller. Hereinafter, display operations are described in the respective modes.

### 5-2-1. Three-Dimensional Video Display Mode

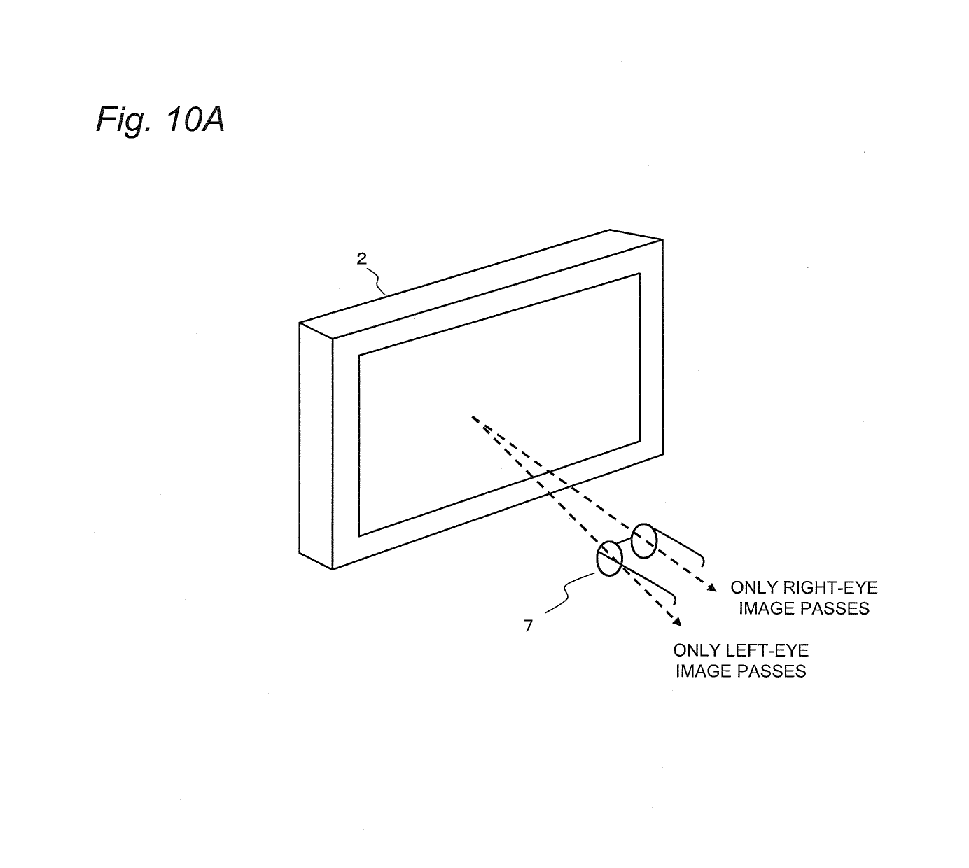

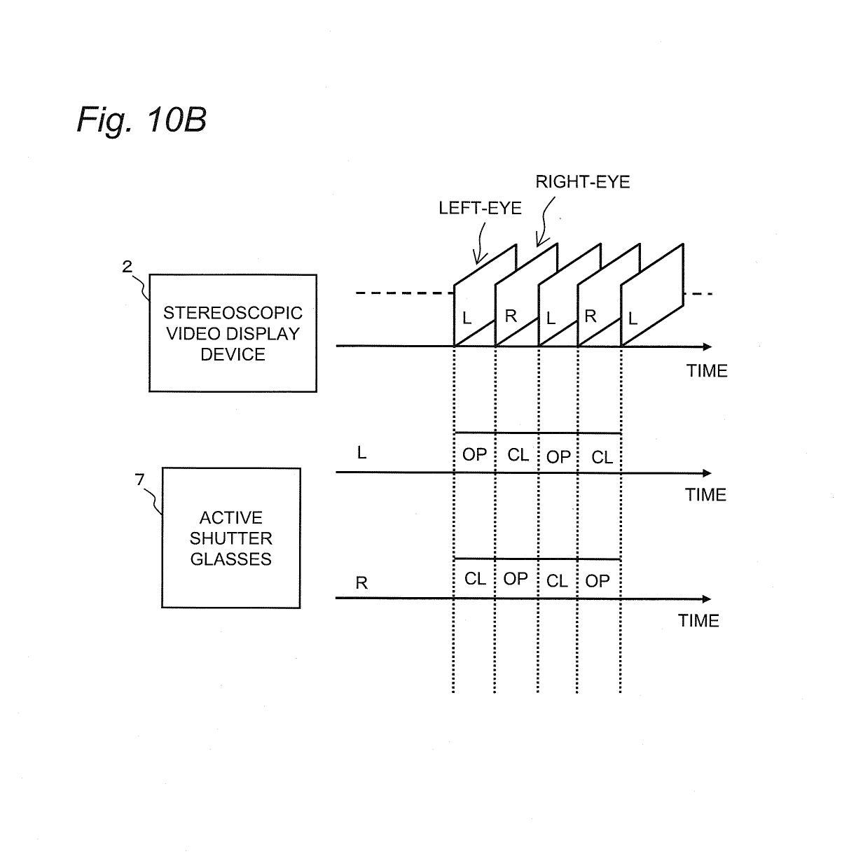

The operation in the three-dimensional video display mode is described referring to FIGS. 10A and 10B. The stereoscopic video display device 2 displays images enabling stereoscopic viewing using the active shutter glasses 7 (see FIG. 10A). More specifically, the stereoscopic video processing device 1 outputs the image data indicated by the left-eye image and the image data indicated by the right-eye image alternately to the stereoscopic video display device 2. The stereoscopic video display device 2 alternately displays the left-eye image and the right-eye image included in the image data obtained from the stereoscopic video processing device 1 on a screen of the display (see FIG. 10B). A viewer views the images displayed on the stereoscopic video display device 2 with the active shutter glasses 7, so that the viewer can visually recognize them as stereoscopic images.

The active shutter glasses 7 are equipped with a shutter for blocking one of visual fields of the viewer's left and right eyes. The shutter of the active shutter glasses 7 is controlled so that the visual field of the viewer's right eye toward the stereoscopic video display device 2 is blocked when the left-eye image is displayed on the stereoscopic video display device 2, and the visual field of the viewer's left eye toward the stereoscopic video display device 2 is blocked when the right-eye image is displayed on the stereoscopic video display device 2. Accordingly, as illustrated in FIGS. 10A and 10B, the viewer views the image with his left eye when the screen showing the left-eye image is displayed on the stereoscopic video display device 2, and the viewer views the image with his right eye when the screen showing the right-eye image is displayed on the stereoscopic video display device 2. As a result of the shutter control, the viewer can visually recognize the screens displayed serially on the stereoscopic video display device 2 as stereoscopic images.

When instructed by a viewer (through the remote controller) to display on the display screen the image with the device image of the stereoscopic video display device 2 (hereinafter, called “display device image”) superimposed thereon, the controller 22 of the stereoscopic video display device 2 superimposes the display device image on the image data and displays the resulting image data. The data of the display device images is stored in the memory 23. The display device image includes, for example, information of channels and sound volume, information used to adjust luminance, degree of contrast, and color temperature of the display, and information used to adjust an image quality of a reproduction apparatus.

Specifically, the controller 22 superimposes the display device image on the image data and displays the resulting image data as described below. The controller 22 decides the parallax information (for example, Z+α pixels) of the display device image based on the parallax information (for example, Z pixels) included in the output data of the stereoscopic video processing device 1. Then, the controller 22 superimposes the display device image based on the decided parallax information. The superimposition is performed in the same manner as described in relation to the stereoscopic video processing device 1, therefore, is not described again. Accordingly, the display device image having a less sense of visual discomfort for displayed image can be superimposed even on the image processed by the stereoscopic video processing device 1. Accordingly, the viewer can view a three-dimensional image without feeling a sense of visual discomfort.

The present embodiment has been described with the example in which the active shutter glasses 7 are used, however, other methods can be employed as long as the viewer can view the left-eye image and the right-eye image displayed on the stereoscopic video display device 2 separately from each other.

The parallax information included in the output data may be used for the following purpose other than the parallax adjustment of the display device image.

In the case where the stereoscopic video display device has a function that allows a viewer to adjust in-screen parallax, the parallax information can be used as described below. First, the stereoscopic video display device presents an image to a viewer by a pop-out amount of a stereoscopic image decided based on the parallax information included in the output data transmitted from the stereoscopic video processing device. Then, the stereoscopic video display device adjusts the pop-out amount of the stereoscopic image based on an instruction from a viewer inputted through, for example, a remote controller. In this manner, the viewer can adjust the parallax in an easy way similarly to the adjustment of sound volume.

As the parallax of a stereoscopic image is larger, a viewer suffers more eye strain. Therefore the stereoscopic video display device, for example, detects a parallax dimension based on the parallax information included in the output data from the stereoscopic video processing device and performs an automatic display limiting in the case where the detected parallax dimension is larger than a predefined value. The display limiting adjusts a display position of a whole display screen so that the parallax of an object between the left-eye image and the right-eye image is reduced. With this configuration, a function for reducing a viewer's eye strain that may be caused by stereoscopic viewing can be realized.

### 5-2-2. Two-Dimensional Video Display Mode

The two-dimensional video display mode is described. The two-dimensional video display mode is a mode in which two-dimensional images displayed based on the stereoscopic video information. According to the two-dimensional video display mode, the stereoscopic video display device 2 displays either one of the left-eye image and the right-eye image on the display 24. During the mode, the active shutter glasses 7 are inactive. That is, light is transmitted through the active shutter glasses 7 to reach both eyes. According to the two-dimensional video display mode, a viewer can view a two-dimensional image without using the active shutter glasses 7.

According to the two-dimensional video display mode, the controller 22 of the stereoscopic video display device 2 selects one of the left-eye image and the right-eye image to be displayed based on the identification information (information indicating one of the left-eye image and the right-eye image having a higher average bit rate for coding than the other) included in the output data from the stereoscopic video processing device 1. The controller 22 selects one of the images indicated by the identification information (for example, left-eye image) and displays the selected image on the display 24. Thus referring to the identification information, the stereoscopic video display device 2 can recognize the image compressed with a higher average bit rate. During the two-dimensional display, therefore, one of the images having a better image quality can be selectively presented to a viewer.

When changing the video information to be transmitted, between three-dimensional video information (stereoscopic video information) and two-dimensional video information during HDMI-transmission of the video information between the stereoscopic video processing device and the stereoscopic video display device, authentication process is necessary between the stereoscopic video processing device and the stereoscopic video display device. During the authentication, the stereoscopic video display device suspends the image display. Therefore, the re-authentication becomes necessary whenever the video information to be transmitted is switched between the three-dimensional video information (stereoscopic video information) and the two-dimensional video information. This interrupts the image display, which is a great disadvantage for a viewer during the image viewing. To solve this problem, according to the present embodiment, the two-dimensional video display mode is provided, so that the stereoscopic video display device 2 can switch the format of the image to be displayed between the three-dimensional display which enables stereoscopic viewing and the two-dimensional display which disables stereoscopic viewing while receiving the three-dimensional video information (stereoscopic video information) from the stereoscopic video processing device 1. This makes it unnecessary to perform the authentication, thereby avoiding the disadvantage that the image viewing is interrupted every time the display format is switched between the stereoscopic display and the two-dimensional display. Further, one of the images having a higher average bit rate can be identified during the two-dimensional video display mode by referring to the identification information, and thus one of the images having a better image quality can be selectively displayed to a viewer.

### 6. Exemplary Operations of Stereoscopic Video Display System

### 6-1. Operation for Displaying Stereoscopic Images

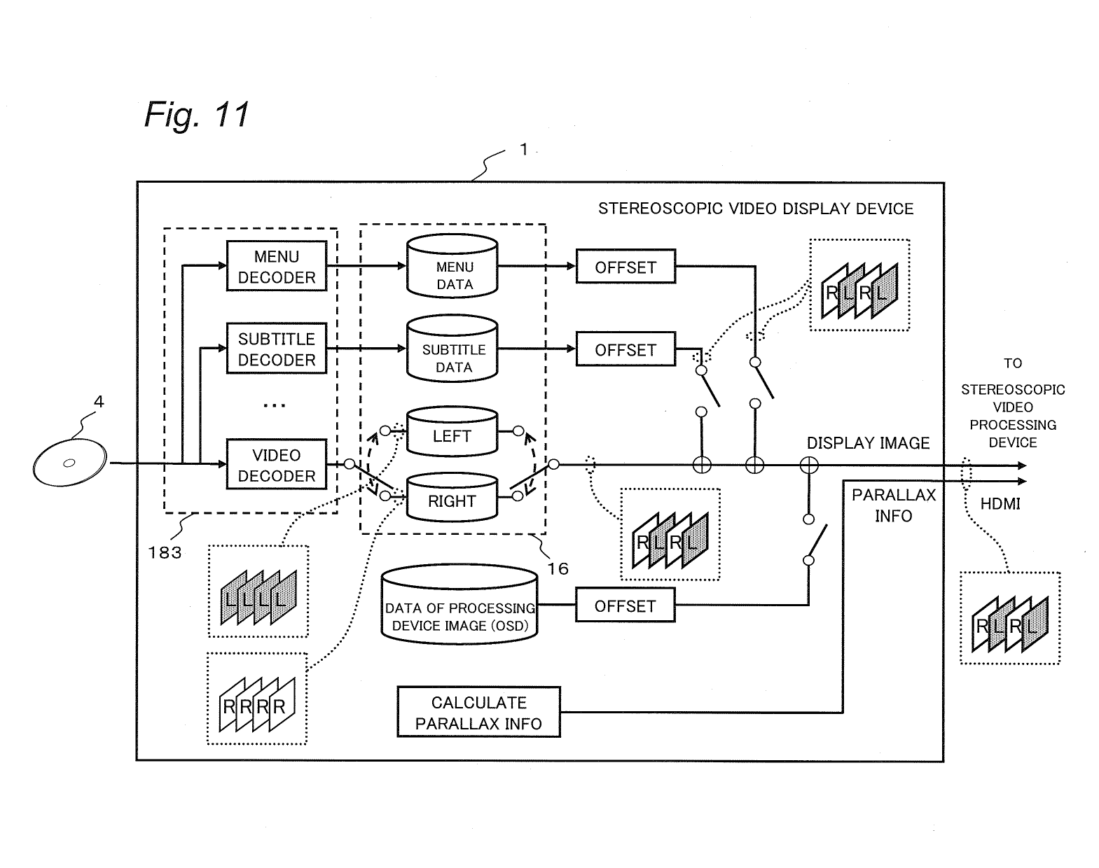

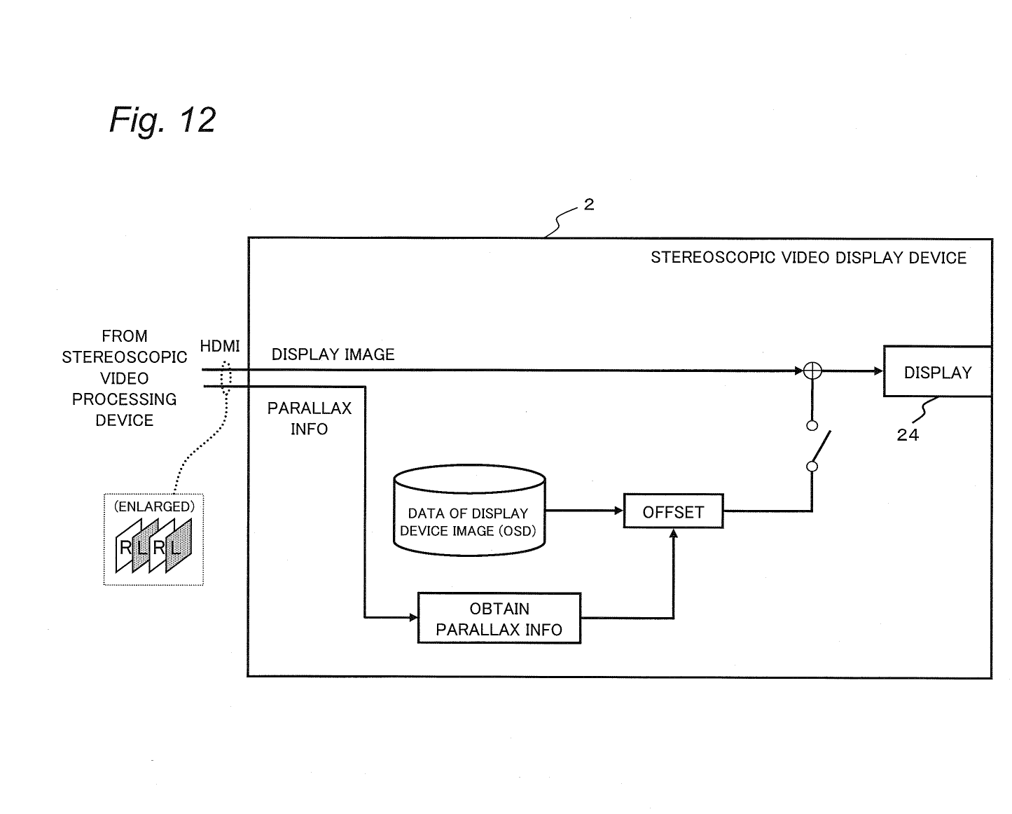

With reference to FIGS. 11 and 12, an operation performed when a three-dimensional image is displayed during the three-dimensional video display mode is specifically described. In the description given below, a part of processes is omitted as a matter of convenience, and the three-dimensional video display mode is set in the stereoscopic video display device 2.

With reference to FIG. 11, an operation of the stereoscopic video processing device 1 is described. As illustrated in FIG. 11, the stereoscopic video processing device 1 obtains the stereoscopic video stream from the optical disc 4. The stereoscopic video processing device 1 splits the obtained stereoscopic video stream into header information, coded stereoscopic video information, audio information, and data information. Then, the stereoscopic video processing device 1 decodes the respective data using the decoder 183 (different decoders, respectively) and records the decoded data on the buffer memory 16 (different regions, respectively).

The stereoscopic video processing device 1 reads out the left-eye image data and the right-eye image data in turn. The stereoscopic video processing device 1 superimposes the subtitle data and menu data on the stereoscopic video information (left-eye image data or right-eye image data) depending on an instruction inputted by a viewer. In this case, the stereoscopic video processing device 1 decides positions of the subtitle data and menu data in the left-eye image and the right-eye image using the parallax information (subtitle parallax information and sub-image parallax information) included in the header information of the stereoscopic video stream and then superimposes these pieces of data on the stereoscopic video information.

Further, the stereoscopic video processing device 1 superimposes the processing device image (OSD) on the stereoscopic video information depending on an instruction inputted by a viewer. The stereoscopic video processing device 1 decides the parallax information of the processing device image based on the subtitle parallax information and the sub-image parallax information and then superimposes the processing device image based on the decided parallax information. As a result, the display image information is generated.

The stereoscopic video processing device 1 calculates the maximum parallax information of the display image. More specifically, information of the largest parallax among the parallax information of the superimposed images (subtitle, sub-image) is used as the maximum parallax information.

The stereoscopic video processing device 1 transmits the calculated parallax information with the display image information to the stereoscopic video display device 2 as output data.

With reference to FIG. 12, an operation of the stereoscopic video display device 2 that has received the display image information and the parallax information from the stereoscopic video processing device 1 is described. The stereoscopic video display device 2 displays the display images on the display sequentially based on the received display image information. In this case, the stereoscopic video display device 2 superimposes the display device image (OSD) on the stereoscopic video information and displays the resulting image depending on an instruction inputted by a viewer. The stereoscopic video display device 1 decides the parallax information of the display device image using the parallax information included in the output data from the stereoscopic video processing device 1 and superimposes the display device image on the stereoscopic image based on the decided parallax information.

Accordingly, the stereoscopic video display device 2 can superimpose the display device image at a position on the display image where a sense of visual discomfort imposed on a viewer is minimized when the display image is stereoscopically viewed.

### 6-2. Exemplary Operation for Displaying Two-Dimensional Images

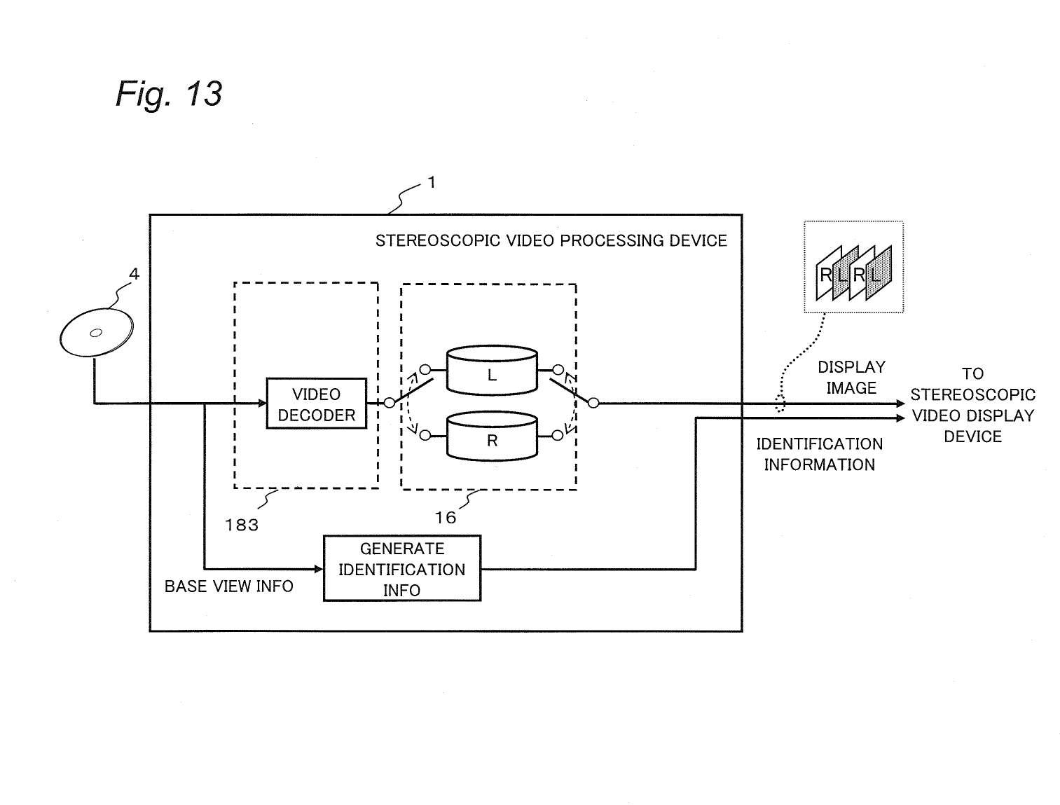

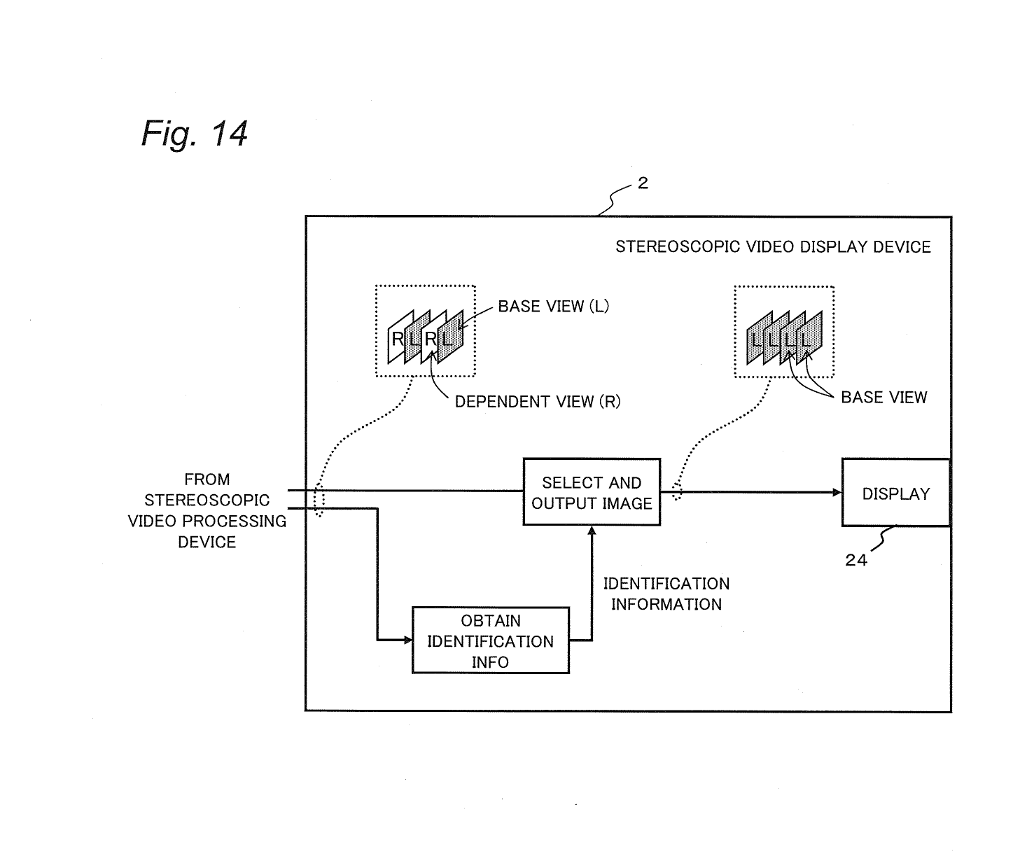

With reference to FIGS. 13 and 14, an operation performed when a two-dimensional image is displayed during the two-dimensional video display mode is described. In the description given below, a part of processes is omitted as a matter of convenience. The two-dimensional video display mode is set in the stereoscopic video display device 2.

With reference to FIG. 13, an operation of the stereoscopic video processing device 1 is described. As illustrated in FIG. 13, the stereoscopic video processing device 1 obtains the stereoscopic video stream from the optical disc 4. The stereoscopic video processing device 1 splits the obtained stereoscopic video stream into header information, coded stereoscopic video information, audio information, and data information. Then, the stereoscopic video processing device 1 decodes the respective data using the decoder 183 (different decoders, respectively). The stereoscopic video processing device 1 records the decoded data on the buffer memory 16 (different regions, respectively).

The stereoscopic video processing device 1 reads out alternately the left-eye image data and the right-eye image data. The stereoscopic video processing device 1 detects the base view information included in the header information 33 of the stereoscopic video stream and transmits the detected base view information as the identification information, together with the display image, to the stereoscopic video display device 2, as output data.

With reference to FIG. 14, an operation of the stereoscopic video display device 2 that has received the display image information and the identification information from the stereoscopic video processing device 1 is described. As illustrated in FIG. 14, the stereoscopic video display device 2 selects one of the left-eye image and the right-eye image from the received display image information and displays the selected image. The stereoscopic video display device 2 selects one of the left-eye image and the right-eye image based on the identification information included in the output data. Thus, by referring to the identification information, the stereoscopic video display device 2 can recognize one of the left-eye image and the right-eye image having a better image quality in a facilitated manner.

### 7. Summary

As described above, the stereoscopic video processing device 1 according to the present embodiment can output the stereoscopic video information that enables stereoscopic viewing to the stereoscopic video display device 2. The stereoscopic video processing device 1 includes: the disc drive 11 (an example of obtaining unit) for obtaining the stereoscopic video information, the AV input/output circuit 184 (an example of superimposing unit) for superimposing additional video information (at least one of the subtitle information, sub-image information, and processing device image) on the stereoscopic video information, and a data transmission interface 15 (an example of transmitting unit) for transmitting the parallax information of the additional video information to the video display device 2 with the parallax manner being associated with the stereoscopic video information on which the additional video information is superimposed.

According to the above configuration, the stereoscopic video processing device 1 can transmit the parallax information of the stereoscopic video information subjected to the image process (decoding) to the video display device 2 in an easier manner. By using the parallax information thus transmitted, the video display device 2 can locate the display device image (OSD) at a more suitable position, thereby displaying the display device image (OSD) to a viewer without making the viewer feel a sense of visual discomfort.

Further, the stereoscopic video processing device 1 according to the present embodiment can transmit the stereoscopic video information including the first and second eye images and enabling stereoscopic viewing, to the video display device 2. The video processing device 1 includes the disc drive 11 (an example of obtaining unit) for obtaining the stereoscopic video information coded by a coding technique (for example MVC) which codes the first and second eye images with different bit rates, the decoder 183 (an example of decoding unit) for decoding the stereoscopic video information, and the data transmission interface 15 (an example of transmitting unit) for transmitting the identification information indicating one of the first and second eye images having a higher bit rate for coding than the other to the video display device 2 with the identification information being associated with the decoded stereoscopic video information.

According to the above configuration, the video processing device 1 can notify the video display device 2 of which of the first and second eye images has a better image quality in an easy manner. Accordingly, the video display device 2 can select one of the first and second eye images having a better image quality than the other. By displaying two-dimensionally the selected image, the video display device 2 can present a two-dimensional image having a good image quality to a viewer.

### 8. Other Embodiments

So far has been described an embodiment of the invention. However, the technical idea of the invention is not necessarily limited to the embodiment but can be variously implemented. Hereinafter, another embodiment of the invention is described.

The embodiment so far has described the example in which the optical disc is used as the video source of the coded stereoscopic video information, however, the video source is not limited thereto. A broadcast station, a server, and a memory card are other examples of the video source to which the technical idea is applicable.

According to the embodiment described so far, one of the images (left-eye image and right-eye image) that is included in the coded stereoscopic video information and has a higher average bit rate than the other is detected by referring to the identification information based on the base view information included in the header information 33. However, the invention is not necessarily limited thereto.

For example, the base view information may be stored in management information (play list) included in the stereoscopic video stream, and by using the management information, one of the images having a higher average bit rate may be detected. The management information is provided at the beginning of the stereoscopic video stream.

The image having a higher average bit rate may be detected by observing the bit rate of the coded stereoscopic video information.

The average bit rate may be calculated as an average value during a predetermined section of the coded stereoscopic video information or may be calculated as an average value of the whole coded stereoscopic video information.

According to the embodiment described so far, the identification information and the maximum parallax information are included in the reserved region and then outputted. However, the invention is not necessarily limited thereto. The identification information and the maximum parallax information may be transmitted through a control line as a CEC (Consumer Electronic Control) command of HDMI.

According to the present embodiment, the subtitle information is superimposed on the left-eye image and the right-eye image in the video content based on the parallax information. The invention is not necessarily limited thereto, and left-eye subtitle information for the left-eye image and right-eye subtitle information for the right-eye image may be respectively superimposed on the left-eye image and the right-eye image. When thus configured, it is possible to obtain the parallax information of the subtitle by analyzing the left-eye subtitle information and the right-eye subtitle information. It is easier to obtain the parallax information of the subtitle than to obtain the parallax information of the stereoscopic video information. The same holds true the sub-image information.

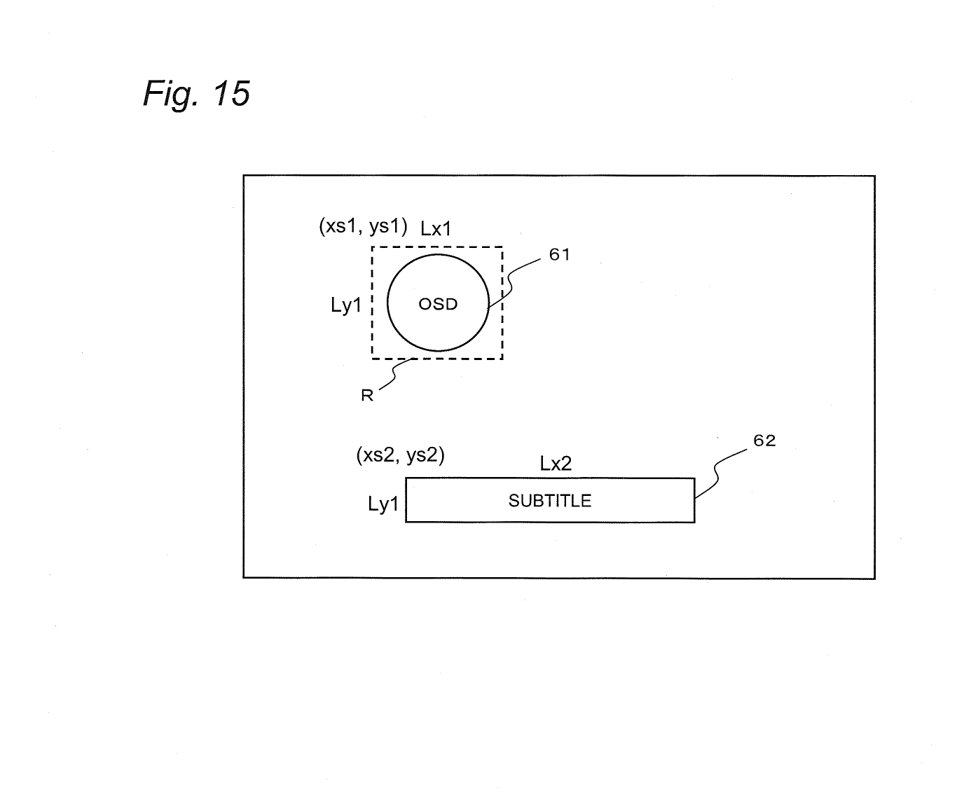

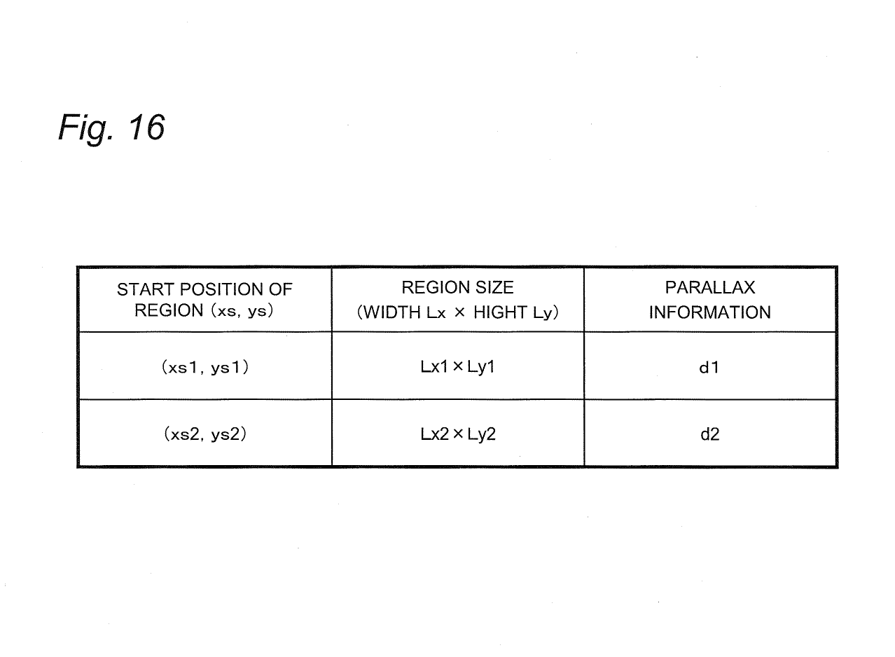

The stereoscopic video processing device 1 according to the present embodiment outputs the parallax information of the maximum parallax in the whole display image, to the stereoscopic video display device 2. However, it may transmit the parallax information for each of regions of the display image. In the case where the display image includes a processing device image 61 and a subtitle 62 as illustrated in FIG. 15, for example, the stereoscopic video processing device 1 may output parallax information of the processing device image 61 and parallax information of the subtitle 62 to the stereoscopic video display device 2 together with information on the respective regions where these objects are displayed. FIG. 16 illustrates a format used when the parallax information is transmitted in the described manner. As illustrated in FIG. 16, the parallax information is associated with, for each of regions, a starting position of region (xs, ys) and a size of the region (lateral length Lx×vertical length Ly), and then is outputted to the stereoscopic video display device 2. Referring to the parallax information of each region, the stereoscopic video display device 2 can decide the display position of the display device image so that the display device image does not overlap on the object displayed in each region. There may be one, two or more pieces of parallax information and two or more pieces of information on the region.

### INDUSTRIAL APPLICABILITY

The invention is suitably applicable to an apparatus capable of outputting a stereoscopic image to a television receiver or a display which can display a stereoscopic image (for example, video recording apparatus, optical disc reproduction apparatus).

### DESCRIPTION OF REFERENCE SIGNS

1 stereoscopic video processing device
2 stereoscopic video display device
3 server
4 optical disc
5 antenna
6 memory card
7 active shutter glasses
11 disc drive
12 tuner
13 network communication interface
14 memory device interface
15 data transmission interface
16 buffer memory
17 HD drive
18 LSI
181 CPU
182 stream controller
183 decoder
184 AV input/output circuit
185 system bus
186 memory controller
19 flash memory
21 data transmission interface
22 controller
23 memory
24 display
25 communication interface

1. A video processing device capable of outputting stereoscopic video information that enables stereoscopic viewing to a video display device, the video processing device comprising:
an obtaining unit that obtains the stereoscopic video information;
a superimposing unit that superimposes additional video information on the stereoscopic video information, and
a transmitting unit that transmits parallax information of the additional video information to the video display device, with the parallax information being associated with the stereoscopic video information on which the additional video information is superimposed.

2. The video processing device according to claim 1, wherein the additional video information is one of subtitle information, sub-image information, and an image provided by the video processing device.

3. The video processing device according to claim 1, wherein, the parallax information is information indicating parallax of one of the stereoscopic video information and the additional video information that is closest to a viewer when an image is stereoscopically displayed.

4. The video processing device according to claim 1, wherein the transmitting unit transmits information of a region where the additional video information is displayed in addition to the parallax information to the video display device, with the information of the region being associated with the stereoscopic video information.

5. A display apparatus comprising:
a receiving unit that receives the stereoscopic video information and the parallax information from the video processing device according to claim 1;
a display unit that displays the received stereoscopic video information; and
a controller that controls the display of the stereoscopic video information on the display unit based on the received parallax information.
